(19) United States
(12) Patent Application Publication
(10) Pub. No.: US 2008/0107845 A1
(43) Pub. Date: May 8, 2008

(54) Packaging Laminate, A Method In Connection With The Production Of It, And A Packaging Container

(75) Inventors: Kerstin Petersen, Kavlinge (SE); Hakan Olsson, Lomma (SE); Andre Chiquet, Villars-Sur-Glane (CH); Monika Zuppiger, Lausanne (CH)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance SA, Pully (CH)

(21) Appl. No.: 11/792,584

(22) PCT Filed: Dec. 14, 2005
(86) PCT No.: PCT/SE05/01912

§ 371 Date: Jun. 8, 2007

(30) Foreign Application Priority Data
Dec. 22, 2004 (SE) 0403182-9

(51) Int. Cl. B32B 1/08; B29C 63/06

(52) U.S. Cl. 428/34.3; 264/171.27; 428/34.2

(57) ABSTRACT

A packaging laminate for a packaging container for a food product, which packaging laminate comprises an outer polypropylene based heat sealable layer, a paper or paperboard based bulk layer, an aluminium gas barrier layer, and an inside comprising an inner polypropylene based heat sealable layer. The inner polypropylene based heat sealable layer is bonded to the aluminium gas barrier layer by intermediate layers of linear low density polyethylene and ethylene (meth)acrylic acid copolymer or other acid polymer, the ethylene (meth)acrylic acid copolymer or other acid polymer being directly bonded to the aluminium gas barrier layer. The invention also relates to a film intended to form the inside of the packaging laminate, a method in connection with the production of the packaging laminate, and a packaging container formed from the packaging laminate.

### TECHNICAL FIELD

The present invention relates to a packaging laminate for a packaging container for a food product, which packaging laminate comprises an outer polypropylene based heat sealable layer, a paper or paperboard based bulk layer, an aluminium gas barrier layer, and an inside comprising an inner polypropylene based heat sealable layer. The invention also relates to a film intended to form the inside of the packaging laminate, a method in connection with the production of the packaging laminate, and a packaging container formed from the packaging laminate. Such a packaging may be of the type having a plastic top that is heat sealed to the container body, which plastic top preferably has outer polypropylene based layers and an opening device. Alternatively, the packaging container may be fold-formed to a brick shape, from said packaging laminate, hot-filled with the food product, and sealed.

### PRIOR ART AND PROBLEMS

WO2003SE01793 describes a type of packaging container for liquid food, which makes use of heat sealing by induction. The packaging container consists of a first and a second container part that are heat sealed to each other. The first part is of tubular shape and has been formed from a sheet of packaging material coated with thermoplastics and having a core layer of paper or paperboard and at least one layer of aluminium foil. The sheet has a first sealed overlap longitudinal joint between two mutually opposed edge sections of the sheet. The second part, that consists of a plastic top having an opening device, is sealed by a second overlap joint, to the first part.

Another type of packaging container formed from a packaging laminate of the type which is described above is known from, for example, international patent application WO97/02140. From, for example, a flat folded tubular packaging blank of the prior art packaging laminate, packaging containers able to be hot filled, are produced in that the packaging blank is first raised to an open, tubular packaging carton which is sealed at its one end by fold forming and thermosealing of continuous, foldable end panels of the packaging carton, for the formation of a substantially planar bottom (or top) closure. The packaging carton provided with a bottom (or top) is hot filled under sterile conditions (at least 80° C. but below 100° C.) with the relevant contents, e.g. food, through its open end. Thereafter the open end is sealed by an additional fold forming and thermosealing of corresponding end panels of the packaging carton for the formation of a substantially planar top (or bottom) closure.

In connection with the packaging of acidic food products in any of the above described types of packaging containers, such as food products containing or being pickled in acetic acid or some other acid, or food products that during storing release free fatty acids, which is especially the case for citrus or pineapple juices, food products of tomato species or oily food products, problems may arise. In the following, such compounds are denoted as acidic compounds independent of being acids such as acetic acid or free fatty acids released from the food product. Such acidic compounds have been shown to be able to penetrate the inside of the packaging laminate, but not the aluminium gas barrier layer. Thereby, they accumulate at increasing concentrations next to the aluminium foil, and after some time and increased accumulation, they negatively affect the adhesion between the aluminium foil and the liquid tight inside layer based on polypropylene. In worst case, there may be a risk of total loss of adhesion, resulting in that the inside layer forms a loose bag inside the packaging container.

### BRIEF SUMMARY OF THE INVENTION

The present invention has for its object to provide a packaging laminate, a film for such a packaging laminate and a packaging container, by which the above mentioned problems are alleviated or eliminated.

These and other objectives are achieved by:

A packaging laminate for a packaging container for a food product, which packaging laminate comprises an outer polypropylene based heat sealable layer, a paper or paperboard based bulk layer, an aluminium gas barrier layer, and an inside comprising an inner polypropylene based heat sealable layer, in which packaging laminate said inner polypropylene based heat sealable layer is bonded to said aluminium gas barrier layer by intermediate layers of linear low density polyethylene; and ethylene (meth)acrylic acid copolymer or other acid polymer; said ethylene (meth)acrylic acid copolymer or other acid polymer being directly bonded to said aluminium gas barrier layer.

And by:

A film intended to form an inside of a packaging laminate, for a packaging container for a food product, comprising an outer polypropylene based heat sealable layer, a paper or paperboard based bulk layer, and an aluminium gas barrier layer, in which film an ethylene (meth)acrylic acid copolymer or other acid polymer layer is directly bonded to a linear low density polyethylene layer, which in turn is directly bonded to a polypropylene based heat sealable layer in said film.

By “ethylene (meth)acrylic acid copolymer or other acid polymer” is meant ethylene acrylic acid copolymer, ethylene methacrylic acid copolymer or some other acid polymer. By such a (meth)acrylic acid copolymer or other acid polymer layer directly bonded to the aluminium gas barrier layer in the packaging laminate, a very high level of adhesion is provided to the aluminium gas barrier layer, even if acidic compounds are present.

According to a preferred embodiment of the invention, said linear low density polyethylene is chosen from enhanced linear low density polyethylene and metallocene linear low density polyethylene.

By “enhanced linear low density polyethylene” is meant for example what is referred to by Dow as enhanced polyethylene, e.g. ELITE 5400G by Dow.

What is meant by the grade “metallocene linear low density polyethylene” is well known to the skilled man.

The linear low density polyethylene layer provides for a very high level of adhesion both to the (meth)acrylic acid copolymer or other acid polymer layer and to the inner polypropylene based heat sealable layer. Hence, an inside is formed that fulfils the requirements on food contact, heat sealability etc., as well as adhesion requirements, even in case of food products comprising, pickled in or releasing acidic compounds.

### DETAILED DESCRIPTION OF THE INVENTION

According to one aspect of the packaging laminate and the film of the invention, the linear low density polyethylene layer is directly bonded to the inner polypropylene based heat sealable layer. In the preferred embodiment of the invention, the linear low density polyethylene layer is also directly bonded to the ethylene (meth)acrylic acid copolymer or other acid polymer layer, on its other side.

According to another aspect of the invention, the ethylene (meth)acrylic acid copolymer or other acid polymer layer has a thickness of 2-20 μm, preferably 3-12 ρm and even more preferred 4-8 μm.

Together, the ethylene (meth)acrylic acid copolymer or other acid polymer layer, the linear low density polyethylene layer and the inner polypropylene based heat sealable layer have a total thickness of 10-100 μm, preferably 15-60 μm and even more preferred 20-40 μm. Of that total thickness, 10-70%, preferably 15-60% and even more preferred 25-50% is constituted by said inner polypropylene based heat sealable layer. Suitably, the inner polypropylene based heat sealable layer is of a grade that provides for a good adhesion to the linear low density polyethylene layer without using a tie layer, although it is conceivable to use such a tie layer.

A packaging container according to the invention has a container body formed from a packaging laminate according to the above.

A first embodiment of the packaging container has a plastic top that is heat sealed to the container body, which plastic top preferably has outer polypropylene based layers and an opening device.

A second embodiment of the packaging container is fold-formed to a brick shape, from the packaging laminate, hot-filled with the food product, and sealed.

Preferably, the packaging container according to the invention is aseptic, preferably by sterilisation.

In a first embodiment of a method in connection with the production of a packaging laminate according to the invention, a pre-made film comprising the polypropylene based heat sealable layer, the linear low density polyethylene layer, and the ethylene (meth)acrylic acid copolymer or other acid polymer layer is durably joined with the aluminium gas barrier layer. Preferably, the film is joined with the aluminium gas barrier layer in the same nip as that in which the paper or paperboard based bulk layer is joined, by extrusion of an intermediate laminate layer, to the aluminium gas barrier layer. Alternatively, the film is joined with the aluminium gas barrier layer in a subsequent nip.

In a second embodiment of a method in connection with the production of a packaging laminate according to the invention, the polypropylene based heat sealable layer, the linear low density polyethylene layer, and the ethylene (meth)acrylic acid copolymer or other acid polymer layer are durably joined with the aluminium gas barrier layer by co-extrusion coating onto the aluminium gas barrier layer.

In a third embodiment of a method in connection with the production of a packaging laminate according to the invention, a pre-made film comprising the polypropylene based heat sealable layer and the linear low density polyethylene layer is durably joined with the aluminium gas barrier layer that previously has been coated by the ethylene (meth)acrylic acid copolymer or other acid polymer layer.

### BRIEF DESCRIPTION OF THE ACCOMPANYING DRAWINGS

The present invention will now be described in greater detail herein below, with reference to one preferred embodiment and with reference to the accompanying Drawings. In the accompanying Drawings:

FIG. 1 is showing a cross-section of the structure of a preferred film according to the invention, for a packaging laminate according to the invention;

FIG. 2 is showing a cross-section of the structure of a preferred packaging laminate according to the invention;

FIG. 3 is showing a first embodiment of a packaging container according to the invention;

FIG. 4 is showing a second embodiment of a packaging container according to the invention.

### DESCRIPTION OF THE PREFERRED EMBODIMENT

The film 10 according to a preferred embodiment of the invention is composed of three layers; an inner polypropylene based heat sealable layer 12, an intermediate metallocene linear low density polyethylene layer, and an ethylene (meth)acrylic acid copolymer or other acid polymer layer 16. The film may be co-extrusion blown or co-extrusion cast and the grades of the polymers are chosen to fit the production method.

The inner polypropylene based heat sealable layer 12 is called “inner” because it is intended to form the inside of a packaging container comprising the film, i.e. it is intended to be in contact with the food product inside the packaging container. The inner polypropylene based heat sealable layer 12 may be formed of several co-extruded part layers (not shown), optionally of different grades, and in this preferred embodiment it has a thickness of 10 μm.

The inner polypropylene based heat sealable layer 12 is directly bonded, i.e. preferably without a tie layer, to a metallocene linear low density polyethylene layer 15. In this preferred embodiment the metallocene linear low density polyethylene layer 15 is a metallocene linear low density polyethylene (m-LLDPE) layer 15 that has a thickness of 9 μm.

The metallocene linear low density polyethylene layer 15 is in turn directly bonded to an ethylene (meth)acrylic acid copolymer or other acid polymer layer 16. In this preferred embodiment the ethylene (meth)acrylic acid copolymer or other acid polymer layer 16 is an ethylene acrylic acid copolymer or other acid polymer layer 16 that has a thickness of 6 μm. It is intended to be directly bonded to an aluminium gas barrier layer of a packaging laminate.

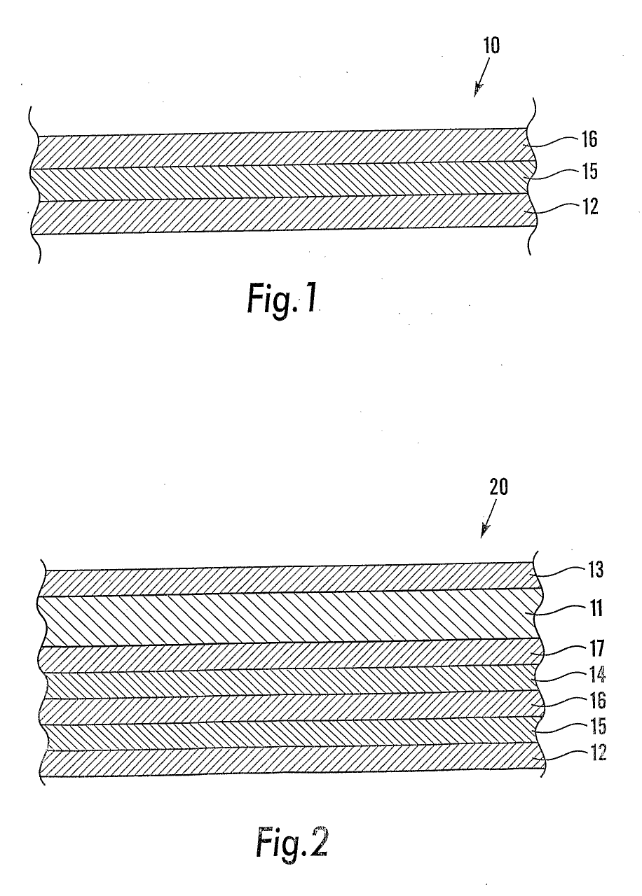

FIG. 2 is showing such a packaging laminate 20 according to a preferred embodiment of the invention. The inside of the packaging laminate 20 is formed of the film 10 shown in FIG. 1. The film 10 has been laminated in a nip, to an aluminium gas barrier layer 14, preferably at the same time as a paper or paperboard based bulk layer 11 is laminated to the aluminium gas barrier layer 14 by means of an intermediate laminate layer 17, that may be polyethylene or polypropylene based. For example such an intermediate polyethylene laminate layer may be made of high density polyethylene or medium density polyethylene or low density polyethylene. In another example such an intermediate propylene-based laminate layer may be made of polypropylene, grafted polypropylene or a combination, such as co-extrusion, of polypropylene and grafted polypropylene. In an alternative embodiment, the inside 12, 15, 16 is (co)extrusion coated directly onto the aluminium gas barrier layer 14.

An outer polypropylene based heat sealable layer 13 forms the outside of the packaging laminate 20. Many variants of the packaging laminate are however conceivable, all having in common though that they have a bulk layer of paperboard, an aluminium gas barrier layer, and an outwardly facing surface based on polypropylene.

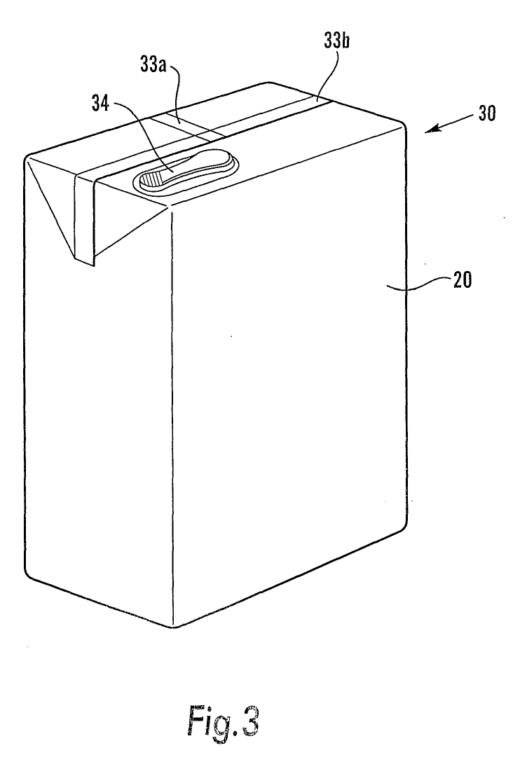

FIG. 3 shows a first embodiment of a packaging container 30 formed of the packaging laminate 20 shown in FIG. 2, which packaging container 30 has longitudinal and transversal seals 33a, 33b, and is hot filled with the food product. It is constituted by a dimension stabile parallelepipedic packaging container. Optionally, the packaging container may have an opening device 34 or it may simply have a perforated tear opening (not shown).

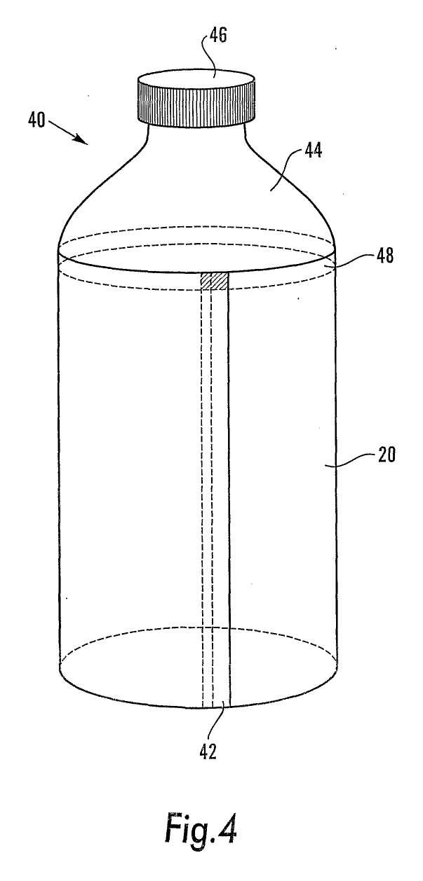

FIG. 4 is showing a second embodiment of a packaging container 40. A plastic top 44 is heat sealed 48 to the inside of the upper end of the packaging laminate 20 that forms a sleeve or container body having a longitudinal seal 42. The plastic top 44 exhibits an opening device 46. In the preferred embodiment, the plastic top has the following cross-sectional structure, as seen from the inside of the top, and out: PP/Adhesive/EVOH/Adhesive/PP. Many variants are however conceivable, all having in common though that they have an outwardly facing surface of PP. The bottom of the sleeve or container body is fold-formed, after filling, and sealed to form a planar bottom.

By way of conclusion it should be observed that the present invention which has been described above with particular reference to the accompanying drawings, is not restricted to these embodiments described and shown exclusively by way of example, and that modifications and alterations obvious to a person skilled in the art are possible without departing from the inventive concept as disclosed in the appended claims.

1. A packaging laminate for a packaging container for a food product, which packaging laminate comprises an outer polypropylene based heat sealable layer, a paper or paperboard based bulk layer, an aluminium gas barrier layer, and an inside comprising an inner polypropylene based heat sealable layer, wherein said inner polypropylene based heat sealable layer is bonded to said aluminium gas barrier layer by intermediate layers of linear low density polyethylene; and ethylene (meth)acrylic acid copolymer or other acid polymer; said ethylene (meth)acrylic acid copolymer or other acid polymer being directly bonded to said aluminium gas barrier layer.

2. A packaging laminate according to claim 1, wherein said linear low density polyethylene layer is directly bonded to said inner polypropylene based heat sealable layer.

3. A packaging laminate according to claim 1, wherein said linear low density polyethylene layer is a metallocene linear low density polyethylene layer.

4. A packaging laminate according to claim 1, wherein said linear low density polyethylene layer is an enhanced linear low density polyethylene layer.

5. A packaging laminate according to claim 1, wherein said linear low density polyethylene layer is directly bonded to said ethylene (meth)acrylic acid copolymer or other acid polymer layer.

6. A packaging laminate according to claim 1, wherein said ethylene (meth)acrylic acid copolymer or other acid polymer layer has a thickness of 2-20 μm.

7. A packaging laminate according to claim 1, wherein a total thickness of said ethylene (meth)acrylic acid copolymer or other acid polymer layer, said linear low density polyethylene layer, and said inner polypropylene based heat sealable layer is 10-100μm.

8. A packaging laminate according to claim 7, wherein said inner polypropylene based heat sealable layer has a thickness of 10-70% of said total thickness.

9. A film intended to form an inside of a packaging laminate, for a packaging container for a food product, comprising an outer polypropylene based heat sealable layer, a paper or paperboard based bulk layer, and an aluminium gas barrier layer, wherein an ethylene (meth)acrylic acid copolymer or other acid polymer layer is directly bonded to a linear low density polyethylene layer, which in turn is directly bonded to a polypropylene based heat sealable layer in said film.

10. A film according to claim 9, wherein said linear low density polyethylene layer is a metallocene linear low density polyethylene layer.

11. A film according to claim 9, wherein said linear low density polyethylene layer is an enhanced linear low density polyethylene layer.

12. A film according to claim 9, wherein said ethylene (meth)acrylic acid copolymer or other acid polymer layer has a thickness of 2-20 μm.

13. A film according to claim 9, wherein a total thickness of said ethylene (meth)acrylic acid copolymer or other acid polymer layer, said linear low density polyethylene layer, and said polypropylene based heat sealable layer is 10-100 μm.

14. A film according to claim 13, wherein said polypropylene based heat sealable layer has a thickness of 10-70% of said total thickness.

15. A packaging container including a food product, wherein the packaging container has a container body formed from a packaging laminate according to claim 1.

16. A packaging container according to claim 15, wherein the packaging container has a plastic top that is heat sealed to the container body, which plastic top has outer polypropylene based layers and an opening device.

17. A packaging container according to claim 15, wherein the packaging container is fold-formed to a brick shape, from said packaging laminate, hot-filled with said food product, and sealed.

18. A method in connection with the production of the packaging laminate according to claim 1, wherein a pre-made film comprising said polypropylene based heat sealable layer, said linear low density polyethylene layer, and said ethylene (meth)acrylic acid copolymer or other acid polymer layer is durably joined with said aluminium gas barrier layer.

19. A method according to claim 18, wherein said film is joined with said aluminium gas barrier layer in a nip which is the same nip as that in which said paper or paperboard based bulk layer is joined, by extrusion of an intermediate laminate layer, to said aluminium gas barrier layer.

20. A method in connection with the production of the packaging laminate according to claim 1, wherein said polypropylene based heat sealable layer, said linear low density polyethylene layer, and said ethylene (meth)acrylic acid copolymer or other acid polymer layer are durably joined with said aluminium gas barrier layer by co-extrusion coating onto said aluminium gas barrier layer

21. A method in connection with the production of the packaging laminate according to claim 1, wherein a pre-made film comprising said polypropylene based heat sealable layer and said linear low density polyethylene layer is durably joined with said aluminium gas barrier layer coated by said ethylene (meth)acrylic acid copolymer or other acid polymer layer.

22. A packaging laminate according to claim 1, wherein said ethylene (meth)acrylic acid copolymer or other acid polymer layer has a thickness of 3-12 μm.

23. A packaging laminate according to claim 1, wherein said ethylene (meth)acrylic acid copolymer or other acid polymer layer has a thickness of 4-8 μm.

24. A packaging laminate according to claim 1, wherein a total thickness of said ethylene (meth)acrylic acid copolymer or other acid polymer layer, said linear low density polyethylene layer, and said inner polypropylene based heat sealable layer is 15-60 μm.

25. A packaging laminate according to claim 1, wherein a total thickness of said ethylene (meth)acrylic acid copolymer or other acid polymer layer, said linear low density polyethylene layer, and said inner polypropylene based heat sealable layer is 20-40 μm.

26. A packaging laminate according to claim 7, wherein said inner polypropylene based heat sealable layer has a thickness of 15-60% of said total thickness.

27. A packaging laminate according to claim 7, wherein said inner polypropylene based heat sealable layer has a thickness of 25-50% of said total thickness.

28. A film according to claim 9, wherein said ethylene (meth)acrylic acid copolymer or other acid polymer layer has a thickness of 3-12 μm.

29. A film according to claim 9, wherein said ethylene (meth)acrylic acid copolymer or other acid polymer layer has a thickness of 4-8 μm.

30. A film according to claim 9, wherein a total thickness of said ethylene (meth)acrylic acid copolymer or other acid polymer layer, said linear low density polyethylene layer, and said polypropylene based heat sealable layer is 15-60 μm.

31. A film according to claim 9, wherein a total thickness of said ethylene (meth)acrylic acid copolymer or other acid polymer layer, said linear low density polyethylene layer, and said polypropylene based heat sealable layer is 20-40 μm.

32. A film according to claim 13, wherein said polypropylene based heat sealable layer has a thickness of 15-60% of said total thickness.

33. A film according to claim 13, wherein said polypropylene based heat sealable layer has a thickness of 15-60% of said total thickness.
